(19) United States
(12) Patent Application Publication
(10) Pub. No.: US 2015/0132093 A1
(43) Pub. Date: May 14, 2015

(54) GRAIN UNLOADER FOR COMBINE HARVESTER

(71) Applicant: AGCO Corporation, Hesston, KS (US)

(72) Inventors: Joseph M. BIGGERSTAFF, Wichita, KS (US); Frederic DUCROQUET, Newton, KS (US); Steven R. TIPPERY, Newton, KS (US)

(21) Appl. No.: 14/496,338

(22) Filed: Sep. 25, 2014

Related U.S. Application Data
(60) Provisional application No. 61/882,327, filed on Sep. 25, 2013.

(51) Int. Cl. A01D 41/12

(52) U.S. Cl. CPC A01D 41/1217
USPC 414/523

(57) ABSTRACT

A combine has a grain bin with a sump and an unloading system for unloading grain out of the bin. The unloading system has a pivoting unloading tube assembly movable between a storage position and an unloading position. The unloading tube assembly has an inner riser section and a variable-length outer transport section. When the unloading tube assembly is in the storage position, at least a portion of the inner riser section nests underneath a rear floor portion of the grain bin. The variable-length transport section has a proximal chute nested with a distal chute that can be moved relative the proximal chute. A nested conveyor assembly transports grain through the variable-length section. The nested conveyor assembly includes an endless conveyor and pulleys configured to form an upper grain transporting reach inside of the chutes and a return reach outside of the chutes.

### CROSS REFERENCE TO RELATED APPLICATIONS

This application claims priority to U.S. Provisional Application No. 61/882,327 filed Sep. 25, 2013, entitled “GRAIN UNLOADER FOR COMBINE HARVESTER”

### BACKGROUND OF THE INVENTION

1. Field of Invention

The present disclosure is generally related to combine harvesters and, more particularly, is related to crop dispensing mechanisms from a combine harvester.

2. Description of Related Art

Harvesting and threshing machines, often called combine harvesters, typically have an onboard storage tank or bin for the collection and temporary storage of the harvested material. Prior art methods of unloading grain from the grain bin of the combine or a similar piece of agricultural equipment usually involve providing an unloading tube assembly with the grain bin used to transfer the grain to a transport truck or trailer. The unloading tube typically has an intake located at or near the bottom of the grain bin so that grain is continuously removed even as the level of the grain drops within the grain bin. A screw-type grain auger or grain conveyor is typically used and housed within the unloading tube to convey the grain up and away from the grain bin and into the transport vehicle. Generally, unloading tubes are pivotally rotated from a storage position alongside the combine harvester to a discharge position away from the grain bin.

There are a number of problems associated with the length of the unloading tube. Combine harvesters are equipped with headers of various lengths depending on conditions and/or combine harvester performance. In applications where the combine harvester discharges the crop from an accompanying vehicle that travels alongside the combine harvester, a wider header results in a need for a longer unloader tube. If the length of the unloading tube is too short, it is difficult to position the truck bed under the distal end of the unloading tube, particularly if the combine continues cutting grain while unloading. If the length of the unloading tube is too long, the unloading tube is difficult to store during nonuse. Also, in rough grain fields, the extreme twisting and vibration encountered during use is amplified along the length of unloading tube, thereby increasing the risk of danger and premature failure. The unloading tube length generally is fixed and limited by the practical distance that it can extend beyond the rear of the combine in its stowed position without creating a serious maneuvering hazard.

The need exists for an improved grain bin unloading configuration for the transfer of grain from the harvesting combine to the transport vehicle.

### OVERVIEW OF THE INVENTION

In one embodiment, the invention is directed to a combine harvester having a grain bin with a sump and a rear floor portion. The combine also has a grain unloading system for transporting grain out of the bin from the sump. The unloading system has a pivoting unloading tube assembly movable between a storage position and an unloading position. The unloading tube assembly has an inner riser section and an outer transport section, the inner riser section being oriented at a first angle with respect to the combine and the outer transport section being oriented at a second angle with respect to the combine with the first angle being greater than the second angle such that the inner riser section has a greater slope than the outer transport section. When the unloading tube assembly is in the storage position, at least a portion of the inner riser section nests underneath the rear floor portion of the grain bin.

In another embodiment, the invention is directed to a combine harvester having a grain bin and a grain unloading system for transporting grain out of the bin. The unloading system includes a variable-length unloading tube assembly having a proximal chute nested with a distal chute that can be moved relative the proximal chute. The unloading system also includes a nested conveyor assembly used to transport the grain through the variable-length unloading tube assembly. The nested conveyor assembly includes an endless conveyor belt and a plurality of pulleys configured to form an upper grain transporting reach of the endless conveyor which is inside the chutes and a return reach of the endless convey which is outside the chutes. The grain transporting reach of the endless conveyor conforms to the shape of a lower circumference of the chutes.

These and other features and advantages of this invention are described in, or are apparent from, the following detailed description of various exemplary embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a schematic diagram showing a combine harvester having grain unloading system according to an embodiment of the invention;

FIG. 2 is a schematic diagram of the combine harvester of FIG. 1 with the grain unloading system in a discharge position unloading grain to an adjacent transport vehicle;

FIG. 3 is a schematic diagram of an example unloader tube assembly in a retracted condition;

FIG. 4 is a schematic diagram of the example unloader tube assembly in an extended condition;

FIG. 5 is a schematic diagram showing, in cut-away view, an embodiment of an unloader tube assembly within the grain unloading system.

Corresponding reference characters indicate corresponding parts throughout the views of the drawings.

### DESCRIPTION OF EXAMPLE EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

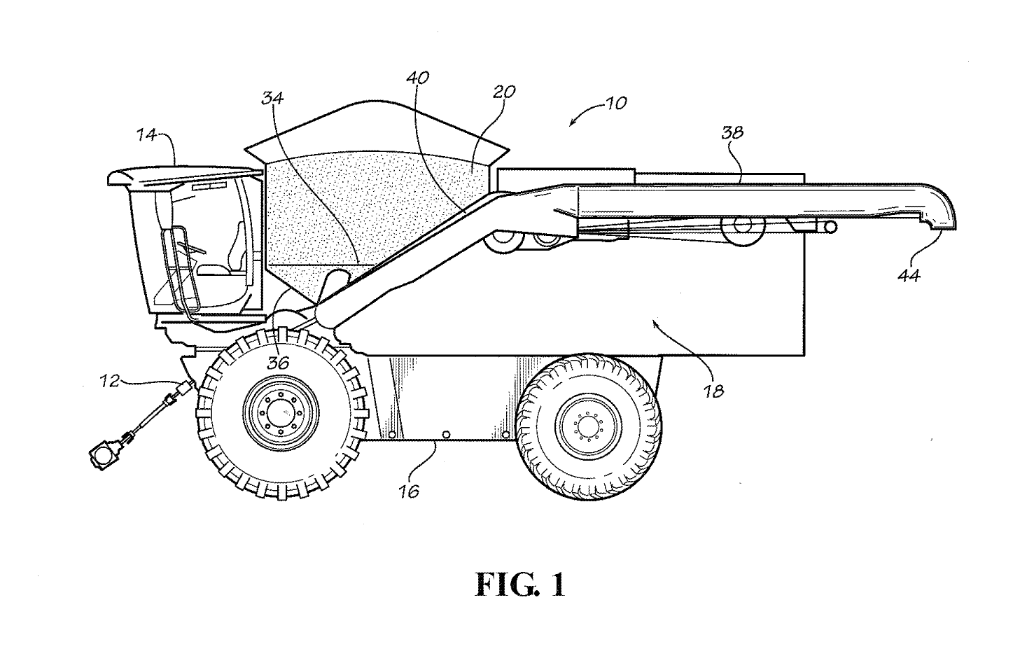

Referring now to FIG. 1, shown is an example embodiment of a combine harvester 10. It should be understood by one having ordinary skill in the art that in the context of the present disclosure, the example combine harvester 10 shown in FIG. 1 is merely illustrative and other combine configurations may be implemented in some embodiments. The example combine harvester 10 is shown in FIG. 1 without a header, and from front to back, comprises a feeder house 12 and an operator cab 14 supported on a chassis 16, followed by a processing system 18 that includes a plurality of components collectively embodied in a combine core (e.g., with threshing and separating functionality) and a cleaning system. In operation, the combine harvester 10 includes a harvesting header at the front of the machine that cuts crop materials and delivers the cut crop materials to the front end of the feeder house 12. The processing system 18 processes the crop materials in known manner and passes a portion of the crop material (e.g., heavier chaff, corn stalks, etc.) toward the rear of the combine harvester 10 and another portion (e.g., grain and possibly light chaff) to a cleaning system of the processing system 18 to undergo a cleaning process. As combine processing and its associated components are known to those having ordinary skill in the art, further discussion of the same is omitted here for brevity.

The cleaned grain from the processing system 18 is delivered by a well-known elevator mechanism (not shown) which conveys the grain to an onboard grain bin 20 located at the top of the combine harvester 10. The onboard grain bin 20 is supported by the chassis 16 by any known means using sound engineering judgment. The onboard grain bin 20 comprises raised walls to support the grain holding capacity of the bin 20.

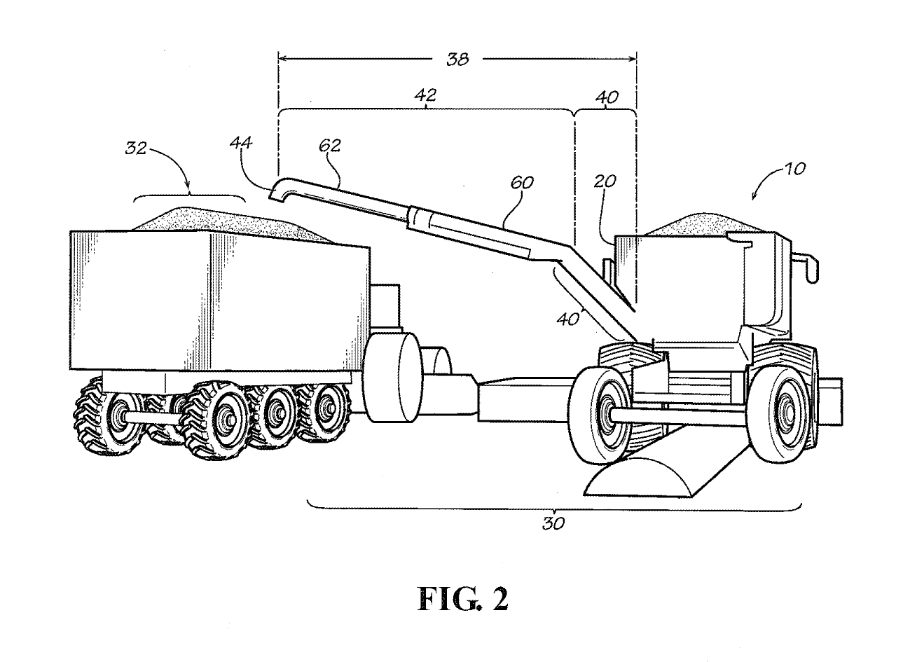

The combine harvester 10 is equipped with a grain bin unloading system 30 used to unload the onboard grain bin 20. FIG. 2 depicts the combine harvester 10 using the grain bin unloading system 30 to transfer grain from the grain bin 20 to a transport vehicle 32. In one embodiment, a sump 34 is positioned in a lower portion 36 of the grain bin 20. Desirably, the combination of gravity and a feeding mechanism, such as a drag auger (not shown), moves grain in the grain bin 20 into the sump 34. The sump 34 serves as an intake to an unloading tube assembly 38 that conveys the grain up and away from the grain bin 20 and into the transport vehicle 32. As is known in the art, the unloading tube assembly 38 is pivotally mounted on the chassis 16 such that it can be pivotally rotated from a storage position alongside the combine harvester 10 as seen in FIG. 1 to an offload or discharge position away from the grain bin 20 as seem in FIG. 2. Any mechanism may be used for pivoting the unloading tube assembly 38 using sound engineering judgment.

The unloading tube assembly 38 has an inner riser section 40 and an outer transport section 42. A first end of the inner riser section 40 connects to the sump 34 in the lower portion 36 of the grain bin 20. The inner riser section 40 is oriented at a first angle with respect to the chassis 16 and the outer transport section 42 is oriented at a second angle with respect to the chassis 16. As can be seen in the illustrated embodiment, the first angle is greater than the second angle such that the inner riser section 40 has a greater slope than the outer transport section 42 of the unloading tube assembly 38. The outer transport section 42 may fixedly connect to the inner riser section 40, or the outer transport section 42 may be pivotally connected to the inner riser section 40. The outer transport section 42 has a grain nozzle 44 at its outer end to direct the flow of grain into the transport vehicle 32.

As best seen in FIG. 1, when the unloading tube assembly 38 is in the storage position, at least a portion of the inner riser section 40 tucks underneath a rear floor portion 46 of the grain bin 20. Desirably, as best seen in FIG. 1, the inner riser section 40 slopes upward at an angle substantially the same as that of the rear floor portion 46 of the grain bin 20 such that when the unloading tube assembly 38 is in the storage position, the inner riser section 40 nests underneath the rear floor portion 46 of the grain bin 20.

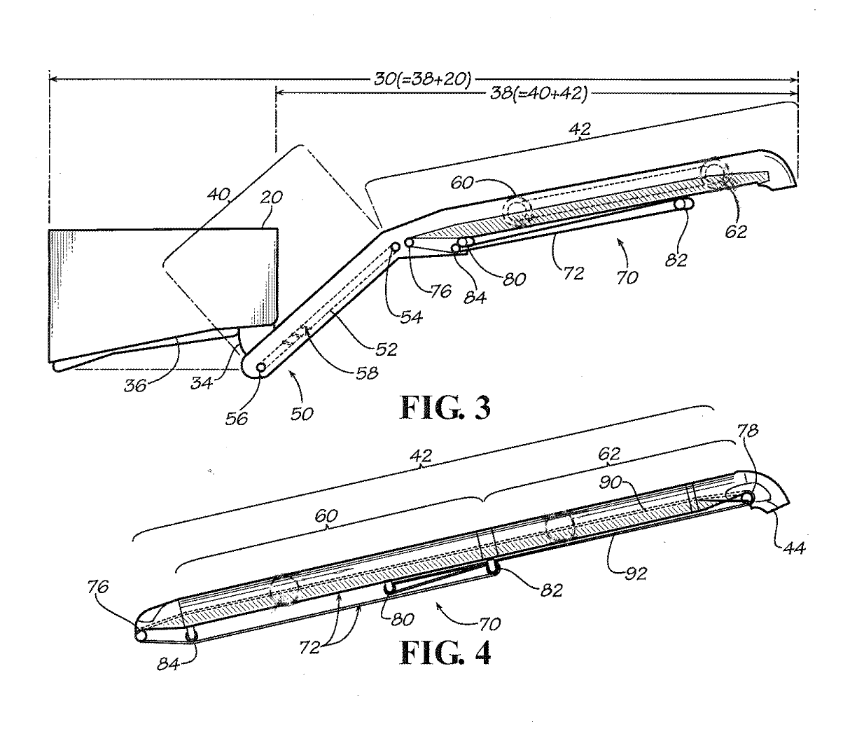

Turning now to FIG. 3, the grain bin unloading system 30 has a first grain transport mechanism 50 in the inner riser section 40 of the unloading tube assembly 38. In one embodiment, the first grain transport mechanism 50 may be a first endless belt 52 positioned around inner pulleys 54, 56. The first endless belt 52 may have a plurality of paddles 58 used to move the grain up the inner riser section 40 of the unloading tube assembly 38. Alternately, the first grain transport mechanism 50 may have an auger assembly including an auger shaft and helical flights that rotate in the inner riser section 40 of the unloading tube assembly 38.

Turning also now to FIG. 4, in one embodiment the length of the outer transport section 42 can be varied. The variable-length outer transport section 42 includes a proximal chute 60 nested with a distal chute 62 that can be moved in or out relative the proximal chute 60 in a telescoping manner. The distal chute 62 may be extended from the proximal chute 60 through any means using sound engineer judgment, such as with a rack and pinion associated with a hydraulic motor, to move from a retracted position such as is illustrated in FIG. 3 to an extended position such as is illustrated in FIG. 4.

The variable-length transport section 42 contains a nested conveyor assembly 70 used to transport the grain through the outer transport section 42. The nested conveyor assembly 70 includes an endless conveyor belt 72. The endless conveyor 72 is desirably driven by a motor, such as a hydraulic motor, which connects to drive pulley 76. From fixed drive pulley 76, belt 72 goes to a stationary pulley 78 located in distal chute 62, back to a moveable pulley 80, to fixed pulley 82, to idler pulley 84, and back to drive pulley 76.

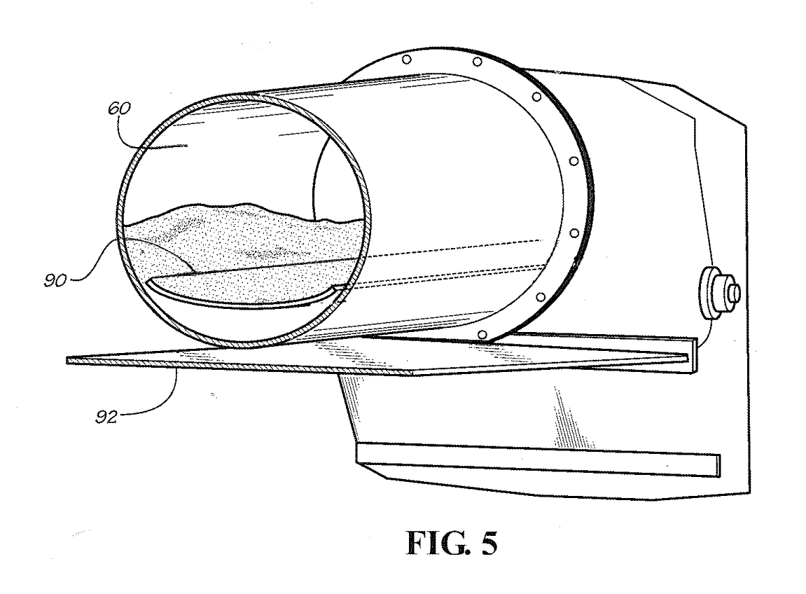

Turning also now to FIG. 5, an upper grain-carrying reach 90 of the endless conveyor 72 is inside the grain transporting proximal and distal chutes 60, 62 while a return reach 92 of the endless convey 72 is outside the proximal and distal chutes 60, 62. The grain-carrying reach 90 of the endless conveyor 72 conforms substantially to the shape of a lower circumference of the chutes 60, 62. The return reach 92 of the endless belt 72 may be covered with a shroud or other suitable covering attached to the unloading tube assembly 38.

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention.

1. A combine harvester comprising:
a grain bin having a sump and a rear floor portion;
a grain unloading system for transporting grain out of the bin from the sump, the unloading system having a pivoting unloading tube assembly movable between a storage position and an unloading position, the unloading tube assembly comprising an inner riser section and an outer transport section, the inner riser section being oriented at a first angle with respect to the combine and the outer transport section being oriented at a second angle with respect to the combine with the first angle being greater than the second angle such that the inner riser section has a greater slope than the outer transport section, and when the unloading tube assembly is in the storage position, at least a portion of the inner riser section is section positioned underneath the rear floor portion of the grain bin.

2. A combine harvester having a grain bin and a grain unloading system for unloading grain out of the grain bin, the unloading system comprising:
a variable-length unloading tube assembly having a proximal chute and a distal chute, the distal chute being moveable in a telescoping manner relative the proximal chute; and
a nested conveyor assembly used to transport the grain through the variable-length unloading tube assembly, the nested conveyor assembly comprising an endless conveyor belt and a plurality of pulleys configured to form an upper grain-transporting reach of the endless conveyor, the upper grain-transporting reach being inside the proximal and distal chutes, and a return reach of the endless convey, the return reach being outside the proximal and distal chutes.

3. The combine harvester of claim 2 wherein the grain-transporting reach of the endless conveyor conforms to the shape of a lower portion of the proximal and distal chutes.
